(19) United States
(12) Patent Application Publication
(10) Pub. No.: US 2024/0243254 A1
(43) Pub. Date: Jul. 18, 2024

(54) COMPOSITE PARTICLES FOR RECHARGEABLE BATTERY AND RECHARGEABLE BATTERY INCLUDING SAME

(71) Applicant: SAMSUNG SDI CO., LTD., Yongin-si (KR)

(72) Inventors: Jinseok BAEK, Yokohama-shi (JP); Kunihiro INUI, Yokohama-shi (JP)

(21) Appl. No.: 18/416,685

(22) Filed: Jan. 18, 2024

(30) Foreign Application Priority Data
Jan. 18, 2023 (JP) 2023-005601

(51) Int. Cl. H01M 4/36; H01M 4/02; H01M 4/131; H01M 4/1391

(52) U.S. Cl. CPC H01M 4/364; H01M 4/131; H01M 4/1391; H01M 2004/021; H01M 2004/028

(57) ABSTRACT

Composite particles for a non-aqueous electrolyte rechargeable battery are provided. The composite particles may suppress or reduce the rise in an internal temperature of the battery including environments where the internal temperature is likely to rise.

### CROSS-REFERENCE TO RELATED APPLICATION

The present application claims priority to and the benefit of Japanese Patent Application No. 2023-005601, filed on Jan. 18, 2023, in the Japanese Intellectual Property Office, the entire content of which is incorporated herein by reference.

### BACKGROUND

### 1. Field

According to one or more embodiments, the present disclosure relates to composite particles for a non-aqueous electrolyte rechargeable battery and a non-aqueous electrolyte rechargeable battery including the same.

### 2. Description of the Related Art

Non-aqueous electrolyte rechargeable batteries including rechargeable lithium ion batteries are widely utilized as power sources for smart phones, notebook computers, and/or the like. More recently non-aqueous electrolyte rechargeable batteries are also utilized for large-sized batteries such as those for vehicles (e.g., electrical vehicles (EVs)).

The rechargeable lithium ion batteries may provide the advantage of relatively high energy density, but because they utilize non-aqueous electrolytes, sufficient operational and handling measures are required for adequate safety. Also, with the recent increase in the size of batteries, maintaining and securing safety has become more important.

For example, if (e.g., when) a rechargeable lithium ion battery is placed in a high-temperature environment, there is a possibility that the positive electrode of the rechargeable lithium ion battery may generate a substantial quantity of heat. In some cases, a substantial quantity of heat may be generated from the oxidative decomposition reaction of the electrolyte, e.g., caused by oxygen radicals generated from the positive electrode, that may result in an increase in the internal temperature of the battery.

If (e.g., when) the internal temperature of the battery becomes very high (e.g., due to such causes as described herein), a short circuit due to shrinkage of the separator provided in the rechargeable lithium ion battery is likely to occur. The short circuit may create a risk of a gradual increase of the internal temperature of the battery.

Accordingly, as a method of ensuring operational and handling safety by suppressing an internal temperature rise of a rechargeable lithium ion battery, it has been proposed to incorporate a binder including a radical scavenging agent such as phosphate ester with radical trapping ability into the positive electrode (Patent Document 1, Japanese Patent Publication No. 2011-159484) or incorporate endothermic particles made of a metal hydroxide with endothermic properties (Patent Document 2, Japanese Patent Publication No. 2016-162528 and Patent Document 3, Japanese Patent Publication No. 2011-258481), the entire content of each of these three Patent Documents 1, 2, and 3 is incorporated herein by reference.

### SUMMARY

According to the present inventors' insight and examination, an internal temperature of a battery cannot be sufficiently suppressed or reduced simply by incorporating the radical scavenger e.g., in, the related art and the inorganic particles, e.g., in the related art, alone into a non-aqueous electrolyte rechargeable battery such as a rechargeable lithium ion battery.

For example, the cycle characteristics of the battery may deteriorate by adding heat suppressing additives such as endothermic particles or radical scavengers as described herein. Accordingly, the present disclosure is made in view of the preceding mentioned concerns, and its purpose is to provide composite particles for non-aqueous electrolyte rechargeable batteries that can sufficiently suppress or reduce an increase in an internal temperature of a battery and suppress or reduce a decline in battery performance such as cycle characteristics. For example, the present disclosure includes the following configurations.

One or more aspects are directed toward composite particles for a non-aqueous electrolyte rechargeable battery including a metal hydroxide and a flame retardant,

wherein an amount of desorbed P₂ (MS1) of the composite particles from about 80° C. to about 1400° C. by thermal desorption gas mass spectrometry (TDS-MS) may be greater than or equal to about 200×10⁻⁶ mole per gram (mol/g) and less than or equal to about 2500×10⁻⁶ mol/g, an amount of desorbed H₂O (MS2) from about 80° C. to about 200° C. by TDS-MS of the composite particles may be greater than or equal to about 50×10⁻⁶ mol/g and less than or equal to about 1000×10⁻⁶ mol/g, and an integrated value of 50% (D₅₀) of a volume-based particle size distribution of the composite particles may be greater than or equal to about 0.1 micrometer (μm) and less than or equal to about 8 μm.

In some embodiments, the specific surface area (BET) of the composite particles calculated by an adsorption isotherm measured by adsorbing nitrogen to the composite particle may be greater than or equal to about 8 m²/g and less than or equal to about 80 m²/g.

In some embodiments, a ratio (e.g., amount) of the amounts of desorbed gases MS1 and MS2 satisfies Formula (1):

$$0.5 \leq ( MS 1 / MS 2 ) \leq 10. . \qquad ( 1 )$$

In some embodiments, the metal hydroxide may be at least one selected from among aluminum hydroxide, pseudo-boehmite, boehmite, alumina, and kaolinite, and a surface and an interior of the metal hydroxide are modified with a flame retardant.

In some embodiments, the flame retardant includes at least one of phosphoric acid, phosphoric acid ester, phosphonic acid, or phosphinic acid.

In some embodiments, a content (e.g., amount) of an aluminum element may be about 1 mass % to 50 mass % and a content (e.g., amount) of a phosphorus element may be about 1 mass % to about 50 mass % as determined by inductively coupled plasma emission spectroscopy (ICP-AES).

In some embodiments, the composite particles, an amount of desorbed CH₄ (MS3) from about 80° C. to about 1400° C. by TDS-MS may be greater than or equal to about 30×10⁻⁶ mol/g and less than or equal to about 500×10⁻⁶ mol/g, and in the composite particles, an amount of desorbed CH₃OH (MS4) from about 80° C. to about 1400° C. by TDS-MS may be greater than or equal to about 500×10⁻⁶ mol/g and less than or equal to about 3000×10⁻⁶ mol/g.

In some embodiments, an amount of desorbed C₆H₆ (MS5) from about 80° C. to about 1400° C. by TDS-MS may be greater than or equal to about 100×10⁻⁶ mol/g and less than or equal to about 3000×10⁻⁶ mol/g.

The metal hydroxide may have a D₅₀ value greater than or equal to about 10 nm and less than or equal to about 10 μm.

An amount of the metal hydroxide may be greater than or equal to about 1 mass % and less than or equal to about 50 mass %, based on a total weight of the composite particles.

An amount of the flame retardant may be greater than or equal to about 0.1 mass % and less than or equal to about 90 mass %, based on a total weight of the composite particles.

In some embodiments, the composite particles for a non-aqueous electrolyte rechargeable battery may be included in an amount of greater than or equal to about 0.1 mass % and less than or equal to about 3.0 mass %, based on a total weight of the non-aqueous electrolyte rechargeable battery.

One or more aspects are directed toward a positive electrode for a non-aqueous electrolyte rechargeable battery, including a positive electrode current collector and a positive electrode mixture layer on the positive electrode current collector, wherein the positive electrode mixture layer includes a positive electrode active material and the composite particles.

One or more aspects are directed toward a non-aqueous electrolyte rechargeable battery including a positive electrode, a negative electrode, a separator, and a non-aqueous electrolyte, wherein the positive electrode may be the positive electrode for the non-aqueous electrolyte rechargeable battery as described herein.

One or more aspects are directed toward a method of preparing composite particles for a non-aqueous electrolyte rechargeable battery, including the process of mixing raw materials of metal hydroxide particles and a flame retardant and heating them.

In some embodiments, the composite particles for non-aqueous electrolyte rechargeable batteries configured in this way have both (e.g., simultaneously) the radical trapping ability due to the flame retardant (e.g. phosphoric acid compound) and the endothermic ability due to the metal hydroxide. In some embodiments, the composite particles have an optimal or suitable particle diameter such that it may be possible to sufficiently suppress or reduce the increase in internal temperature in the non-aqueous electrolyte rechargeable battery and suppress or reduce a decline in battery performance.

### BRIEF DESCRIPTION OF THE DRAWINGS

The preceding and other aspects, features, and advantages of certain embodiments of the present disclosure will be more apparent from the following description taken in conjunction with the accompanying drawings, in which:

FIG. 1 is a schematic view showing a structure of a composite particle according to some embodiments of the present disclosure.

FIG. 2 is a graph showing capacity retention rates of battery cells according to Example 6 and Comparative Examples 1, 3, and 4.

FIG. 3 is a graph showing the effect of suppressing positive electrode heat generation in Example 6 and Comparative Examples 1, 3, and 4.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described, by referring to the drawings, to explain aspects of the present description. As utilized herein, the term “and/or” includes any and all combinations of one or more of the associated listed items. Expressions such as “at least one of,” if (e.g., when) preceding a list of elements, modify the entire list of elements and do not modify the individual elements of the list.

As the present disclosure described hereinafter allows for one or more suitable changes and numerous embodiments, embodiments will be illustrated in the drawings and described in more detail in the detailed description.

Hereinafter, embodiments will be described in more detail so that those of ordinary skill in the art can easily implement them. However, this disclosure may be embodied in many different forms and is not construed as limited to the example embodiments set forth herein.

The terminology utilized herein is utilized to describe embodiments, and is not intended to limit the present disclosure. The singular expression includes the plural expression unless the context clearly dictates otherwise. Unless otherwise defined, all chemical names, technical and scientific terms, and terms defined in common dictionaries should be interpreted as having meanings consistent with the context of the related art, and should not be interpreted in an ideal or overly formal sense. It will be understood that, although the terms first, second, etc. may be used herein to describe various elements, these elements should not be limited by these terms. These terms are only used to distinguish one element from another element. Thus, a first element could be termed a second element without departing from the teachings of the present disclosure. Similarly, a second element could be termed a first element.

As utilized herein, “combination thereof” refers to a mixture, laminate, composite, copolymer, alloy, blend, reaction product, and/or the like of the constituents.

As used herein, singular forms such as “a,” “an,” and “the” are intended to include the plural forms as well, unless the context clearly indicates otherwise.

As used herein, the terms “use,” “using,” and “used” may be considered synonymous with the terms “utilize,” “utilizing,” and “utilized,” respectively.

As used herein, expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Herein, it should be understood that terms such as “comprises,” “comprise,” “comprising,” “includes,” “including,” “include,” “having,” “has,” or “have” are intended to designate the presence of an embodied feature, number, step, element, or a combination thereof, but it does not preclude the possibility of the presence or addition of one or more other features, number, step, element, or a combination thereof.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

In this context, “consisting essentially of” means that any additional components will not materially affect the chemical, physical, optical or electrical properties of the semiconductor film.

Further, in this specification, the phrase “on a plane,” or “plan view,” means viewing a target portion from the top, and the phrase “on a cross-section” means viewing a cross-section formed by vertically cutting a target portion from the side.

In present disclosure, “not include a or any ‘component’”, “exclude a or any ‘component’”, “‘component’-free”, and/or the like refers to that the “component” not being added, selected or utilized as a component in the composition, but the “component” of less than a suitable amount may still be included due to other impurities and/or external factors.

In the drawings, the thickness of layers, films, panels, regions, and/or the like, are exaggerated for clarity and like reference numerals designate like elements throughout, and duplicative descriptions thereof may not be provided the specification. It will be understood that if (e.g., when) an element such as a layer, film, region, or substrate is referred to as being “on” another element, it can be directly on the other element or intervening element(s) may also be present. In contrast, if (e.g., when) an element is referred to as being “directly on” another element, there are no intervening elements present.

### Definitions

In some embodiments, the term “layer” herein includes not only a shape formed on the whole surface if (e.g., when) viewed from a plan view, but also a shape formed on a partial surface.

In some embodiments, the term “particle diameter” may be an average particle diameter and the average particle diameter may be measured by a method well suitable to those skilled in the art, for example, may be measured by a particle size analyzer (PSA), or may be measured by a transmission electron microscopic (TEM) image or a scanning electron microscopic (SEM) image.

In some embodiments, it may be possible to obtain an average particle diameter value by measuring utilizing a dynamic light scattering method, performing data analysis, counting the number of particles for each particle size range, and calculating from this. Unless otherwise defined, the average particle diameter may refer to the diameter (D₅₀) of particles having a cumulative volume of 50 volume % in the particle size distribution. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or length of the long axis) of about 20 particles at random in a scanning electron microscope image. Also, depending on context, when particles are spherical, “diameter” indicates a particle diameter or an average particle diameter, and when the particles are non-spherical, the “diameter” indicates a major axis length or an average major axis length.

Herein, the term “or” may be not to be construed as an exclusive meaning, for example, “A or B” may be construed to include A, B, A+B, and/or the like.

Herein, the term “metal” may be interpreted as a concept including ordinary metals, transition metals and metalloids (semi-metals).

Hereinafter, a configuration of a non-aqueous electrolyte rechargeable battery according to some embodiments will be described.

### 1. Basic Configuration of Non-Aqueous Electrolyte Rechargeable Battery

The non-aqueous electrolyte rechargeable battery according to this embodiment may be a rechargeable lithium ion battery equipped with a positive electrode, a negative electrode, a separator, and a non-aqueous electrolyte.

The shape of the rechargeable lithium ion battery is not particularly limited, and may be, for example, cylindrical, square, laminate, or button.

### 1-1. Positive Electrode

The positive electrode includes a positive electrode current collector and a positive electrode mixture layer on the positive electrode current collector.

The positive electrode current collector may be any material as long as it is a conductor, and is, for example, plate-shaped or thin, and may be made of aluminum, stainless steel, nickel coated steel, and/or the like.

The positive electrode mixture layer may include at least a positive electrode active material, and may further include a conductive agent and a positive electrode binder.

The positive electrode active material may be, for example, a transition metal oxide or a solid solution oxide including lithium, and is not particularly limited as long as it is a material that can electrochemically intercalate and deintercalates lithium ions. Examples of the transition metal oxide including lithium may include Li_{1.0}Ni_{0.88}Co_{0.1}Al_{0.01}Mg_{0.01}O₂, and/or the like, Li—Co composite oxides such as LiCoO₂ and Li·Ni·Co—Mn-based composite oxides such as LiNiₓCo_{y}Mn_{z}O₂, Li—Ni-based composite oxide such as LiNiO₂, and/or Li—Mn-based composite oxides such as LiMn₂O₄, and/or the like. Examples of the solid solution oxide may include LiₐMnₓCo_{y}Ni_{z}O₂ (1.150≤a≤1.430, 0.45≤x≤0.6, 0.10≤y≤0.15, 0.20≤z≤0.28), or LiMn_{1.5}Ni_{0.5}O₄. On the other hand, a content (e.g., amount) (content ratio) of the positive electrode active material is not particularly limited, as long as it is applicable to the positive electrode mixture layer of a non-aqueous electrolyte rechargeable battery. Moreover, these compounds may be utilized alone or may be utilized in mixture of plural types (kinds).

The conductive agent is not particularly limited as long as it is for increasing the conductivity of the positive electrode. Examples of the conductive agent may include those including at least one selected from among carbon black, natural graphite, artificial graphite, fibrous carbon, and sheet-like carbon. Examples of the carbon black may include furnace black, channel black, thermal black, ketjen black, and acetylene black.

Examples of the fibrous carbon may include carbon nanotubes and carbon nanofibers, and examples of the sheet-like carbon include graphene and/or the like.

A content (e.g., amount) of the conductive agent in the positive electrode mixture layer is not particularly limited, but may be greater than or equal to about 0.1 mass % and less than or equal to about 5 mass %, greater than or equal to about 0.5 mass % and less than or equal to about 3 mass % based on the total amount of the positive electrode mixture layer, from the viewpoint of achieving both (e.g., simultaneously) conductivity and battery capacity.

The positive electrode binder may include, for example, a fluoro-containing resin such as polyvinylidene fluoride, an ethylene-containing resin such as styrene-butadiene rubber, an ethylene-propylene diene terpolymer, an acrylonitrile-butadiene rubber, a fluoro rubber, polyvinyl acetate, polymethylmethacrylate, polyethylene, polyvinyl alcohol, carboxymethyl cellulose, a carboxymethyl cellulose derivative (a salt of carboxymethyl cellulose, and/or the like), nitrocellulose, and/or the like. The positive electrode binder may be any material capable of binding the positive electrode active material and the conductive agent onto the positive electrode current collector, and is not particularly limited.

### 1-2. Negative Electrode

The negative electrode includes a negative current collector and a negative electrode mixture layer on the negative current collector.

The negative current collector may be any suitable material as long as it is a conductor, and may be plate-shaped or thin, and may be made of copper, stainless steel, nickel-plated steel, and/or the like.

The negative electrode mixture layer may include a negative electrode active material, and may further include a conductive agent and a negative electrode binder.

The negative electrode active material is not particularly limited as long as it can electrochemically intercalate and deintercalate lithium ions, but, may be, for example, a graphite active material (artificial graphite, natural graphite, a mixture of artificial graphite and natural graphite, natural graphite coated with artificial graphite), a Si-based active material, or a Sn-based active material (e.g., a mixture of fine particles of silicon (Si) or tin (Sn) or a mixture of oxides thereof and a graphite active material, particulates of silicon or tin, an alloy including silicon or tin as a base material), metallic lithium, and a titanium oxide compound such as Li₄Ti₅O₁₂, lithium nitride, and/or the like. As the negative electrode active material, one of the described examples may be utilized, or two or more types (kinds) may be utilized in combination. On the other hand, oxides of silicon may be represented by SiOₓ (0≤x≤2).

The conductive agent is not particularly limited as long as it is for increasing the conductivity of the negative electrode, and for example, the same conductive agent as described in the section of the positive electrode may be utilized.

A content (e.g., amount) of the conductive agent in the negative electrode mixture layer is not particularly limited, but may be greater than or equal to about 0.1 mass % and less than or equal to about 5 mass %, or greater than or equal to about 0.5 mass % and less than or equal to about 3 mass % based on the total weight of the negative electrode mixture layer, from the viewpoint of achieving both (e.g., simultaneously) conductivity and battery capacity.

The negative electrode binder may be one capable of binding the negative electrode active material and the conductive agent on the negative current collector, and is not particularly limited. The negative electrode binder may be, for example, polyvinylidene fluoride (PVDF), polytetrafluoroethylene (PTFE), polyacrylic acid (PAA), a styrene-butadiene-based copolymer (SBR), a metal salt of carboxymethyl cellulose (CMC), and/or the like. The binder may be utilized alone or may be utilized in mixture of two or more types (kinds).

### 1-3. Separator

The separator is not particularly limited, and any separator may be utilized as long as it is utilized as a separator for a rechargeable lithium ion battery. The separator may be a porous film, nonwoven fabric, and/or the like that exhibits excellent or suitable high-rate discharge performance alone or in combination. The resin constituting the separator may be, for example, a polyolefin-based resin such as polyethylene, polypropylene, and/or the like, a polyester resin such as polyethylene terephthalate, polybutylene terephthalate, and/or the like, polyvinylidene difluoride, a vinylidene difluoride-hexafluoropropylene copolymer, a vinylidene difluoride-perfluorovinyl ether copolymer, a vinylidene difluoride-tetrafluoroethylene copolymer, a vinylidene difluoride-trifluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoro propylene copolymer, a vinylidene difluoride-tetrafluoroethylene copolymer, a vinylidene difluoride-ethylene-tetrafluoroethylene copolymer, and/or the like. On the other hand, a porosity of the separator is not particularly limited, and it is possible to arbitrarily apply a porosity of the separator of a related art rechargeable lithium ion battery.

The separator may further include a surface layer covering the surface of the porous film or non-woven fabric described herein. The surface layer may include an adhesive for immobilizing the battery element by adhering to the electrode. Examples of the adhesive may include a vinylidene fluoride-hexafluoropropylene copolymer, an acid-modified product of vinylidene fluoride polymers, and a styrene-(meth)acrylic acid ester copolymer.

### 1-4. Non-Aqueous Electrolyte

As the non-aqueous electrolyte, substantially the same non-aqueous electrolyte that has conventionally been utilized for rechargeable lithium ion batteries may be utilized without particular limitation. The non-aqueous electrolyte has a composition in which an electrolyte salt is included in a non-aqueous solvent, which is a solvent for the electrolyte. Examples of the non-aqueous solvent may include cyclic carbonate esters such as propylene carbonate, ethylene carbonate, butylene carbonate, chloroethylene carbonate, fluoroethylene carbonate, and vinylene carbonate, cyclic esters such as γ-butyrolactone and γ-valerolactone, chain carbonates such as dimethyl carbonate, diethyl carbonate, or ethylmethyl carbonate, chain esters such as methylformate, methylacetate, methylbutyrate, ethyl propionate, propyl propionate, ethers such as tetrahydrofuran or a derivative thereof, 1,3-dioxane, 1,4-dioxane, 1,2-dimethoxyethane, 1,4-dibutoxyethane, or methyldiglyme, ethylene glycol monopropyl ether, or propylene glycol monopropyl ether, nitriles such as acetonitrile and benzonitrile, dioxolane or a derivative thereof, ethylene sulfide, sulfolane, sultone, or a derivative thereof, which may be utilized alone or in a mixture of two or more. On the other hand, if (e.g., when) two or more types (kinds) of non-aqueous solvents are mixed and utilized, a mixing ratio of each non-aqueous solvent may be a mixing ratio that may be utilized in a related art rechargeable lithium ion battery.

Examples of the electrolyte salt may include an inorganic ion salt including at least one of lithium (Li), sodium (Na) or potassium (K) such as LiClO₄, LiBF₄, LiAsF₆, LiPF₆, LiPF₆₋ₓ(CₙF₂ₙ₊₁)ₓ [provided that 1<x<6 and n=1 or 2], LiSCN, LiBr, LiI, Li₂SO₄, Li₂B₁₀Cl₁₀, NaClO₄, NaI, NaSCN, NaBr, KClO₄, KSCN, KI, and/or KBr; or an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, lithium stearyl sulfonate, lithium octyl sulfonate, lithium dodecylbenzene sulfonate, and/or the like, and it is also possible to utilize these ionic compounds alone or in a mixture of two or more types (kinds). In some embodiments, a concentration of the electrolyte salt may be the same as that of a non-aqueous electrolyte utilized in a rechargeable lithium ion battery, and is not particularly limited. In some embodiments, it is desirable to utilize a non-aqueous electrolyte including the aforementioned lithium compound (electrolytic salt) at a concentration of greater than or equal to about 0.8 mole per liter (mol/L) and less than or equal to about 1.5 mol/L.

In some embodiments, one or more suitable additives may be added to the non-aqueous electrolyte. Examples of such additives may include negative electrode-acting action additives, positive electrode-acting additives, ester additives, carbonate ester additives, sulfuric acid ester additives, phosphoric acid ester additives, boric acid ester additives, acid anhydride additives, and electrolyte additives. One of these may be added to the non-aqueous electrolyte, and a plurality of types (kinds) of additives may be added.

### 2. Configuration of Non-Aqueous Electrolyte Rechargeable Battery According to the Present Embodiment

Hereinafter, the characteristic configuration of the non-aqueous electrolyte rechargeable battery according to some embodiments will be described.

In addition to the aforementioned components, the positive electrode mixture layer of the non-aqueous electrolyte rechargeable battery according to the present embodiment includes composite particles for non-aqueous electrolyte rechargeable batteries (also simply referred to as composite particles) that function as a heat suppressing additive to suppress or reduce internal temperature increase of the battery.

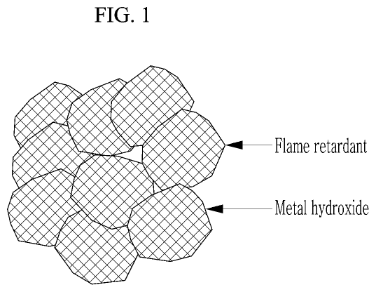

These composite particles are composite particles in which a metal hydroxide capable of absorbing heat through an endothermic reaction and a flame retardant having a radical trapping ability are combined. As shown in FIG. 1, these composite particles are combined after the metal hydroxide particles and the flame retardant are mixed as uniformly as possible. For example, a plurality of metal hydroxide particles including the flame retardant on the surface and inside are gathered together. Herein, the composite refers to, for example, a state in which a plurality of particles are formed into one aggregate by chemically bonding to each other through the functional groups (for example, hydroxyl and phosphate groups) possessed by each particle. The chemical bond herein includes not only covalent bonds but also one or more suitable bonds such as ionic bonds, coordination bonds, and metallic bonds. The bonding state between particles can be confirmed by, for example, X-ray photoelectron spectroscopy. The particle diameter of the composite particles may be such that the integrated value of 50% (D₅₀) of the volume-based particle size distribution may be greater than or equal to about 0.1 micrometer (μm) and less than or equal to about 8 μm. The D₅₀ of the composite particle may be greater than or equal to about 0.5 μm and less than or equal to about 6 μm, and for example, greater than or equal to about 1 μm and less than or equal to about 5 μm.

The particle diameter of the composite particles can be controlled or selected by the preparing conditions of the composite particles. For example, if (e.g., when) the temperature for preparing composite particles is increased or the stirring speed is increased, the particle diameter of the composite particles tends to become smaller. For example, it may be possible to make the particle diameter of the composite particles smaller than the particle diameter of the metal hydroxide that is the starting material.

The metal hydroxide particles may be any endothermic material capable of causing an endothermic reaction and are not particularly limited. Examples of the metal hydroxides include aluminum hydroxide, pseudo-boehmite, boehmite, alumina, and/or kaolinite. These may be utilized alone, or two or more types (kinds) may be utilized together.

The integrated value of 50% (D₅₀) of the volume-based particle size distribution of the metal hydroxide particles may be greater than or equal to about 10 nanometer (nm) and less than or equal to about 10 μm, and for example, greater than or equal to about 50 nm and less than or equal to about 5 μm.

The flame retardant may be any that has a radical trapping ability to capture radicals such as oxygen radicals generated in the positive electrode mixture layer, and may include, for example, at least one type or kind selected from among phosphoric acid, phosphoric acid ester (such as phenyl phosphate and diphenyl phosphate), phosphonic acid (such as methyl phosphonic acid and phenyl phosphonic acid), and phosphinic acid (such as methyl phosphinic acid), which can form a functional group including a phosphorus (P) element by combining with the metal hydroxide.

A content (e.g., amount) of the metal hydroxide particles in the composite particles may be in the range of greater than or equal to about 1 mass % and less than or equal to about 50 mass %, greater than or equal to about 5 mass % and less than or equal to about 30 mass %, or greater than or equal to about 10 mass % and less than or equal to about 20 mass % based on the total weight of the composite particles (100 mass %).

A content (e.g., amount) of the flame retardant in the composite particles may be in the range of greater than or equal to about 0.1 mass % and less than or equal to about 90 mass %, greater than or equal to about 1 mass % and less than or equal to about 85 mass %, or greater than or equal to about 10 mass % and less than or equal to about 80 mass % based on a total weight of the composite particles (100 mass %).

A content (e.g., amount) of composite particles in the positive electrode mixture layer may be in the range of greater than or equal to about 0.1 mass % and less than or equal to about 5 mass %, greater than or equal to about 0.2 mass % and less than or equal to about 3 mass %, or greater than or equal to about 0.5 mass % and less than or equal to about 2 mass % based on a total weight of the positive electrode mixture layer

Within these ranges, sufficient heat suppression effect and good, desired, and/or suitable battery performance can be achieved.

In some embodiments, the content (e.g., amount) of the composite particles for the non-aqueous electrolyte rechargeable battery based on a total mass of the non-aqueous electrolyte rechargeable battery varies depending on the intended utilization of the non-aqueous electrolyte rechargeable battery and is not limited to the following described range. In some embodiments, if (e.g., when) the overall mass of the rechargeable battery is 100 mass %, the content (e.g., amount) of composite particles for non-aqueous electrolyte rechargeable batteries included in the non-aqueous electrolyte rechargeable battery may be greater than or equal to about 0.01 mass % and less than or equal to about 5.0 mass %, greater than or equal to about 0.02 mass % and less than or equal to about 2.0 mass %, or greater than or equal to about 0.1 mass % and less than or equal to about 0.5 mass %.

### 3. Manufacturing Method of Non-Aqueous Electrolyte Rechargeable Battery

Hereinafter, the manufacturing method of the non-aqueous electrolyte rechargeable battery according to the present embodiment is described.

### 3-1. Preparing Method of Composite Particles

The composite particles for a non-aqueous electrolyte rechargeable battery according to the present embodiment can be prepared by mixing metal hydroxide particles and a flame retardant and heating them. For example, a method of preparing the composite particles may include mixing the metal hydroxide particles and the flame retardant to form a mixture (e.g., dispersion) and heating the mixture (e.g., dispersion).

The mixing may be performed, for example, by dispersing the metal hydroxide particles and the flame retardant in an appropriate or suitable solvent and stirring them (e.g., to form a dispersion of the metal hydroxide particles and the flame retardant). Herein, the stirring speed may be greater than or equal to about 50 meter per minute (m/min) and less than or equal to about 500 m/min, or for example greater than or equal to about 100 m/min and less than or equal to about 400 m/min.

The composite particles can be obtained by heating the dispersion to a temperature of, for example, greater than or equal to about 40° C. and less than or equal to about 100° C., reacting at this temperature for greater than or equal to about 1 hour and less than or equal to about 48 hours, and then filtering it with filter paper.

The solvent may be water, or a mixture of water and an alcohol-based organic solvent such as ethanol or 2-propanol.

The heating temperature may be greater than or equal to about 60° C. and less than or equal to about 80° C., and the heating time (reaction time) may be greater than or equal to about 5 hours and less than or equal to about 30 hours.

The fact that the particles produced as described herein have become the target (e.g., are suitable for use as) composite particles may be confirmed, for example, by an amount of one or more suitable degassing due to one or more suitable modifying groups being in the following range.

In some embodiments, if (e.g., when) the composite particles are heated from about 80° C. to about 1400° C., the amount of P₂ gas desorbed from the composite particles measured by TDS-MS (referred to as MS1) may be greater than or equal to about 200×10⁻⁶ mol/g and less than or equal to about 2500×10⁻⁶ mole per gram (mol/g) and the amount of desorbed H₂O (referred to as MS2) may be greater than or equal to about 50×10⁻⁶ mol/g and less than or equal to about 1000×10⁻⁶ mol/g.

MS1 may be greater than or equal to about 300×10⁻⁶ mol/g and less than or equal to about 2000×10⁻⁶ mol/g, or greater than or equal to about 400×10⁻⁶ mol/g and less than or equal to about 1800×10−6 mol/g.

MS2 may be greater than or equal to about 100×10⁻⁶ mol/g and less than or equal to about 950×10⁻⁶ mol/g, or and greater than or equal to about 300×10⁻⁶ mol/g and less than or equal to about 900×10⁻⁶ mol/g.

In some embodiments, a ratio (M1/M2) of the amounts of these desorbed gases may be greater than or equal to about 0.5 and less than or equal to about 10.0, greater than or equal to about 0.5 and less than or equal to about 5.0, or greater than or equal to about 0.8 and less than or equal to about 3.0. If (e.g., when) the ratio (M1/M2) of the amounts of desorbed gases satisfies this range, (1) the temperature increase suppressing effect by increasing the modification by the flame retardant and (2) the battery performance may both (1) and (2) be exhibited in a better balance. For example, the ratio of MS1 and MS2 satisfies Formula (1):

$$0.5 \leq ( MS 1 / MS 2 ) \leq 10. . \qquad ( 1 )$$

In some embodiments, a specific surface area of the composite particles calculated by the adsorption isotherm measured by adsorbing nitrogen to the composite particles may be greater than or equal to about 8 m²/g and less than or equal to about 150 m²/g, greater than or equal to about 8 square meter per gram (m²/g) and less than or equal to about 80 m²/g, greater than or equal to about 10 m²/g and less than or equal to about 75 m²/g, or greater than or equal to about 15 m²/g and less than or equal to about 75 m²/g.

In order to prepare the composite particles including flame retardant that is more modified to the metal hydroxide, it may be desirable to utilize a metal hydroxide as a starting material with as large a specific surface area as possible and to mix the metal hydroxide with a relatively large specific surface area with a flame retardant to set the specific surface area of the composite particles in the preceding mentioned range. The specific surface area of the composite particles tends to decrease if (e.g., when) the amount of flame retardant added to the metal hydroxide is increased or the reaction time if (e.g., when) combining the metal hydroxide and flame retardant is lengthened. Accordingly, the specific surface area of the composite particles can be adjusted by changing these conditions, and thus the specific surface area of the metal hydroxide as the starting material is not particularly limited, but the specific surface area of the metal hydroxide may be, for example, greater than or equal to about 100 m²/g and less than or equal to about 500 m²/g.

For the composite particle according to the present embodiment, it is desirable that the content (e.g., amount) of an Al (aluminum) element and a P (phosphorus) element measured by inductively coupled plasma emission spectroscopy (ICP-AES) may be within the following range.

The content (e.g., amount) of an Al element in the composite particles may be greater than or equal to about 1 mass % and less than or equal to about 50 mass %, greater than or equal to about 3 mass % and less than or equal to about 40 mass %, or greater than or equal to about 5 mass % and less than or equal to about 30 mass %.

The content (e.g., amount) of a P element in the composite particles may be greater than or equal to about 1 mass % and less than or equal to about 50 mass %, greater than or equal to about 3 mass % and less than or equal to about 40 mass %, or greater than or equal to about 5 mass % and less than or equal to about 30 mass %.

In order to further improve the endothermic effect of the composite particles, the composite particles may be modified with functional groups such as CH₃ groups and CH₂OH groups. A degree of modification by these functional groups may be evaluated by the following desorption amounts of one or more suitable gases derived from these functional groups, in substantially the same way as the degree of modification by functional groups including the phosphorus (P) element (e.g., phosphonic acid). It is desirable that the desorption amounts of one or more suitable gases satisfy the following ranges. On the other hand, the desorption amounts of one or more suitable gases can be adjusted depending on the type or kind and content (e.g., amount) of the metal hydroxide and flame retardant utilized in preparing the composite particles.

The amount (referred to as MS3) of desorbed CH₄ gas measured by TDS-MS, which may be the amount of CH₄ gas desorbed from the composite particle if (e.g., when) the composite particle may be heated from about 80° C. to about 1400° C., may be 0, but it may exceed 0 and be less than or equal to about 1000×10⁻⁶ mol/g, greater than or equal to about 10×10⁻⁶ mol/g and less than or equal to about 700×10⁻⁶ mol/g, or greater than or equal to about 30×10⁻⁶ mol/g and less than or equal to about 500×10⁻⁶ mol/g.

The amount of desorbed CH₃OH (referred to as MS4) measured may be 0, but it may exceed 0 and be less than or equal to about 4000×10⁻⁶ mol/g, greater than or equal to about 200×10⁻⁶ mol/g and less than or equal to about 3000×10⁻⁶ mol/g, or greater than or equal to about 500×10⁻⁶ mol/g and less than or equal to about 3000×10⁻⁶ mol/g.

If (e.g., when) the composite particles are modified with a functional group including a phenyl group, it may be easy to disperse the metal hydroxide particles in the solvent if (e.g., when) preparing a slurry utilizing a non-aqueous solvent such as N-methyl-2-pyrrolidone (NMP).

Therefore, the amount (referred to as MS5) of desorbed C₆H₆ from about 80° C. to about 1400° C. by TDS-MS of the metal hydroxide particles may be 0, but may be greater than 0 and less than or equal to about 4000×10⁻⁶ mol/g, greater than or equal to about 10×10⁻⁶ mol/g and less than or equal to about 3000×10⁻⁶ mol/g, or greater than or equal to about 100×10⁻⁶ mol/g and less than or equal to about 3000×10⁻⁶ mol/g.

The total content (e.g., amount) of modified molecules in the composite particles may be in the range of greater than or equal to about 10 mass % and less than or equal to about 99 mass %, greater than or equal to about 20 mass % and less than or equal to about 97 mass %, or greater than or equal to about 30 mass % and less than or equal to about 95 mass % based on 100 mass % of the total composite particles.

### 3-2. Manufacturing Method of Positive Electrode

The positive electrode may be produced as follows. First, a positive electrode slurry may be formed by dispersing a mixture of a positive electrode active material, a conductive agent, a positive electrode binder, and composite particles in a desired or suitable ratio in a solvent for a positive electrode slurry. Next, this positive electrode slurry may be coated on the positive electrode current collector and dried to form a positive electrode mixture layer. On the other hand, the coating method is not particularly limited. The coating method may include a knife coater method, a gravure coater method, a reverse roll coater, a slit die coater, and/or the like. Each of the following coating processes is also performed by the same method. Subsequently, the positive electrode material mixture layer may be pressed by a press to have a desired or suitable density. Thus, a positive electrode may be manufactured.

### 3-3. Manufacturing Method of Negative Electrode

The negative electrode may also be produced in substantially the same way as the positive electrode. First, a negative electrode slurry may be prepared by dispersing a mixture of materials constituting the negative electrode mixture layer in a solvent for a negative electrode slurry. Next, a negative electrode mixture layer may be formed by coating the negative electrode slurry on the negative current collector and drying it. Next, the negative electrode material mixture layer may be pressed by a press machine so as to have a desired or suitable density. Thus, a negative electrode may be manufactured.

### 3-4. Manufacturing Method of Non-Aqueous Electrolyte Rechargeable Battery

Next, an electrode structure may be manufactured by placing a separator between the positive electrode and the negative electrode. Then, the electrode structure may be processed into a desired or suitable shape (e.g., cylindrical shape, prismatic shape, laminated shape, button shape, and/or the like) and inserted into a container of the described shape. Subsequently, a non-aqueous electrolyte may be inserted into the corresponding container to impregnate the electrolyte into each pore in the separator or a gap between the positive electrode and negative electrode. Accordingly, a rechargeable lithium ion battery may be manufactured.

### 4. Effect by the Present Embodiment

According to the non-aqueous electrolyte rechargeable battery configured as described herein, even in an environment where the internal temperature is likely to rise due to battery abnormalities such as internal short circuits, the increase in the internal temperature of the non-aqueous electrolyte rechargeable battery may be sufficiently suppressed or reduced, electrical resistance of the non-aqueous electrolyte rechargeable battery may be suppressed or reduced to a small level, and cycle characteristics may be improved.

### 5. Another Embodiment

The present disclosure is not limited to the aforementioned embodiments.

In the aforementioned embodiment, the case where the positive electrode includes the composite particles according to the present disclosure has been described, but the negative electrode may also include the composite particles. If (e.g., when) including composite particles in the negative electrode, it may be desirable to set the content (e.g., amount) equivalent to that in the case of including them in the positive electrode.

Additionally, the composite particles may be included in the electrolyte, or may be included in multiple locations in the positive electrode, negative electrode, and electrolyte.

If (e.g., when) the negative electrode includes the composite particles for a non-aqueous electrolyte rechargeable battery, a content (e.g., amount) of the composite particles for a non-aqueous electrolyte rechargeable battery based on a total negative electrode may be in substantially the same range as that for the positive electrode. If (e.g., when) the electrolyte includes the composite particles for a non-aqueous electrolyte rechargeable battery, a content (e.g., amount) of the composite particles for a non-aqueous electrolyte rechargeable battery if (e.g., when) the mass of the total electrolyte is 100 mass % may be in the range of about 0.1 mass % to about 10.0 mass %.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

The present disclosure will be described in further detail with reference to the following examples and comparative examples. However, the present disclosure is not limited to these examples but may be variously modified without deviating from the purpose.

### EXAMPLES

Hereinafter, the present disclosure will be described in more detail according to the following examples. However, the following examples are only one example of the present disclosure, and the present disclosure is not limited to the following examples.

### Production of Composite Particles or Particle Mixture

### Example 1

As starting materials, 1.0 g of aluminum hydroxide (D₅₀: 3 micrometer (μm), BET: 205 square meter per gram (m²/g), Manufacturer: Iwatani Chemical Industry Co., Ltd.) and 5.0 g of methyl phosphinic acid were utilized, and these were dispersed in 50 cubic centimeter (cc) of a mixed solution of ethanol and purified water (mixing volume ratio 1:1). This dispersion was heated at 70° C. and a stirring speed of 300 meter per minute (m/min) for 24 hours, filtered with water and ethanol, and washed with water and ethanol, and the solid on the filter paper was vacuum dried to obtain Composite particles A.

### Example 2

Composite particles B were obtained in substantially the same manner as in Example 1, except that 1.0 g of activated alumina (D₅₀: 3 μm, BET: 300 m²/g, Manufacturer: Zibo Yinghe Chemical Co., Ltd.) and 5.0 g of methyl phosphonic acid were utilized as starting materials.

### Example 3

Composite particles C were obtained in substantially the same manner as in Example 1, except that 1.0 g of pseudo-boehmite (D₅₀: 1.8 μm, BET: 384 m²/g, Manufacturer: Zibo Linxi Chemical Co., Ltd.) and 5.0 g of diphenyl phosphate were utilized as starting materials.

### Example 4

Composite particles D were obtained in substantially the same manner as in Example 1, except that 1.0 g of kaolinite (Al₂Si₂O₅(OH)₄, D₅₀: 1 μm, BET: 120 m²/g, Manufacturer: Hebei Jinshi New Materials Technology Co., Ltd.) and 5.0 g of phenyl phosphate were utilized as starting materials.

### Example 5

Composite particles E were obtained in substantially the same manner as in Example 1, except that 1.0 g of pseudo-boehmite (D₅₀: 1.8 μm, BET: 384 m²/g, Manufacturer: Zibo Linxi Chemical Co., Ltd.) and 5.0 g of phenyl phosphonic acid were utilized as starting materials.

### Example 6

Composite particles F were obtained in substantially the same manner as in Example 1, except that 1.0 g of pseudo-boehmite (D₅₀: 1.8 μm, BET: 384 m²/g, Manufacturer: Zibo Linxi Chemical Co., Ltd.) and 1.0 g of diphenyl phosphate were utilized as starting materials.

### Example 7

Composite particles F were obtained in substantially the same manner as in Example 1, except that 1.0 g of pseudo-boehmite (D₅₀: 1.8 μm, BET: 384 m²/g, Manufacturer: Zibo Linxi Chemical Co., Ltd.) and 1.0 g of phenyl phosphate were utilized as starting materials.

### Example 8

Composite particles H were obtained in substantially the same manner as in Example 1, except that 1.0 g of pseudo-boehmite (D₅₀: 1.8 μm, BET: 384 m²/g, Manufacturer: Zibo Linxi Chemical Co., Ltd.) and 5.0 g of methyl phosphinic acid were utilized as starting materials.

### Example 9

Composite particles I were obtained in substantially the same manner as in Example 1, except that 1.0 g of pseudo-boehmite (D₅₀: 1.8 μm, BET: 384 m²/g, Manufacturer: Zibo Linxi Chemical Co., Ltd.) and 5.0 g of phosphoric acid were utilized as starting materials.

### Example 10

Composite particles J were obtained in substantially the same manner as in Example 1, except that 1.0 g of kaolinite (Al₂Si₂O₅(OH)₄, D₅₀: 1 μm, BET: 120 m²/g, Manufacturer: Hebei Jinshi New Materials Technology Co., Ltd.) and 5.0 g of phenyl phosphonic acid were utilized as starting materials.

### Example 11

Composite particles K were obtained in substantially the same manner as in Example 1, except that 1.0 g of kaolinite (Al₂Si₂O₅(OH)₄, D₅₀: 1 μm, BET: 120 m²/g, Manufacturer: Hebei Jinshi New Materials Technology Co., Ltd.) and 5.0 g of methyl phosphonic acid were utilized as starting materials.

### Example 12

Composite particles L were obtained in substantially the same manner as in Example 1, except that 1.0 g of kaolinite (Al₂Si₂O₅(OH)₄, D₅₀: 1 μm, BET: 120 m²/g, Manufacturer: Hebei Jinshi New Materials Technology Co., Ltd.) and 5.0 g of methyl phosphinic acid were utilized as starting materials.

### Example 13

Composite particles M were obtained in substantially the same manner as in Example 1, except that 1.0 g of aluminum hydroxide (D₅₀: 3 μm, BET: 205 m²/g, Manufacturer: Iwatani Chemical Industry Co., Ltd.) and 5.0 g of methyl phosphonic acid were utilized as starting materials.

### Example 14

Composite particles N were obtained in substantially the same manner as in Example 1, except that 1.0 g of aluminum hydroxide (D₅₀: 3 μm, BET: 205 m²/g, Manufacturer: Iwatani Chemical Industry Co., Ltd.) and 5.0 g of phenyl phosphonic acid were utilized as starting materials.

### Example 15

Composite particles O were obtained in substantially the same manner as in Example 1, except that 1.0 g of activated alumina (D₅₀: 3 μm, BET: 300 m²/g, Manufacturer: Zibo Yinghe Chemical Co., Ltd.) and 5.0 g of methyl phosphinic acid were utilized as starting materials.

### Example 16

Composite particles P were obtained in substantially the same manner as in Example 1, except that 1.0 g of activated alumina (D₅₀: 3 μm, BET: 300 m²/g, Manufacturer: Zibo Yinghe Chemical Co., Ltd.) and 5.0 g of phenyl phosphonic acid were utilized as starting materials.

### Comparative Example 5

Composite particles Q were obtained in substantially the same manner as in Example 1, except that 1.0 g of aluminum hydroxide (D₅₀: 18 μm, BET: 125 m²/g, Manufacturer: Iwatani Chemical Industry Co., Ltd.) and 2.0 g of methyl phosphonic acid were utilized as starting materials.

### Comparative Example 6

1.0 g of aluminum hydroxide (D₅₀: 5 μm, BET: 20 m²/g, Manufacturer: Iwatani Chemical Industry Co., Ltd.) and 1.0 g of phosphoric acid were mixed for 10 minutes utilizing a V-type or kind mixer manufactured by Dalton Co., Ltd. to obtain Particle mixture a.

### Comparative Example 7

1.0 g of pseudo-boehmite (D₅₀: 1.8 μm, BET: 384 m²/g, Manufacturer: Zibo Linxi Chemical Co., Ltd.) and 1.0 g of diphenyl phosphate were mixed for 10 minutes utilizing a V-type or kind mixer manufactured by Dalton Co., Ltd. to obtain Particle mixture b.

### Manufacture of Positive Electrode

### Examples 1 to 16 and Comparative Examples 2 to 7

LiCoO₂, acetylene black, and polyvinylidene fluoride, the composite particles, endothermic particles, particle mixtures, or radical scavengers listed in Table 1 (composite particles, endothermic particles, particle mixtures, or radical scavengers are collectively referred to as heat suppressing additives), and polyvinylidene fluoride as a binder are dispersed and mixed in a form of dry powders (solid content (e.g., amount)) including no solvent (excluding a (e.g., any) solvent) in N-methyl-2-pyrrolidone solvent to prepare positive electrode mixture slurries. Next, the slurry was coated on one surface or both (e.g., opposite) surfaces of the aluminum current collector so that the mixture application amount (surface density) after drying was 20.0 milligram per square centimeter (mg/cm²) on one surface, dried, and then pressed with a roll press machine so that the positive electrode mixture layer density was 4.15 gram per cubic centimeter (g/cc) to form a positive electrode mixture layer.

### Comparative Example 1

A positive electrode was manufactured in substantially the same manner as in Example 1, except that LiCoO₂, acetylene black, and polyvinylidene fluoride were dispersed and mixed in N-methyl-2-pyrrolidone solvent in a mass ratio of 97.7:1.0:1.3 as a dry powder (solid content (e.g., amount)) including no solvent (excluding a (e.g., any) solvent) to prepare a positive electrode mixture slurry.

### Manufacture of Negative Electrode

### Examples 1 to 16, Comparative Examples 1 to 7

Artificial graphite, carboxymethyl cellulose sodium salt (CMC), and styrene-butadiene-based water dispersion were dissolved and dispersed in an aqueous solvent so that the mass ratio as dry powder (solid content (e.g., amount)) including no solvent (excluding a (e.g., any) solvent) was 97.5:1.0:1.5, to prepare a negative electrode mixture slurry. Next, the negative electrode mixture slurry was coated and dried on one surface or both (e.g., opposite) surfaces of the copper foil, which is the negative electrode current collector, so that the mixture coating amount (surface density) after drying was 15.0 mg/cm², and then the pressed with a roll press machine to manufacture a negative electrode so that the negative electrode mixture layer density was 1.65 g/cc.

### Manufacture of Rechargeable Battery Cells

### Examples 1 to 16 and Comparative Examples 1 to 7

A plurality of the positive electrodes and a plurality of the negative electrodes were stacked with a polypropylene porous separator between the positive and negative electrodes to have battery design capacity of 300 milliampere-hour (mAh), manufacturing an electrode stack. At this time, as the positive electrode and negative electrode placed inside the electrode stack, mixture layers formed on both (e.g., opposite) surfaces of the current collector were utilized, and for the positive electrode or negative electrode provided on the outermost layer, a mixture layer formed on only one surface was utilized. For example, a positive electrode with an electrode plate area of 8.5 square centimeter (cm²) (on both (e.g., opposite) surfaces, 5 sheets) and a negative electrode with an electrode plate area of 10.0 cm² (4 sheets of both (e.g., opposite) surfaces and 2 sheets of one surface) were manufactured. Subsequently, a rechargeable battery cell before the initial charge was manufactured by welding nickel and aluminum lead wires respectively to the negative and positive electrodes of the electrode stack, housing the electrode stack in an aluminum laminate film with the lead wires externally pulled out (e.g., exposed), injecting an electrolyte thereinto, and sealing the aluminum laminate film under a reduced pressure (e.g., vacuum). The electrolyte was prepared by dissolving 1.3 M LiPF₆ and 1 mass % of vinylene carbonate in a mixed solvent of ethylene carbonate/dimethyl carbonate/fluoroethylene carbonate in a volume ratio of 15/80/5.

### Evaluation of Heat Suppressing Additives

The heat suppressing additives utilized in Examples 1 to 16 and Comparative Examples 1 to 7 were evaluated as follows.

### Element Analysis

Measurements were made in accordance with JIS K0116:2014 utilizing an inductively coupled plasma emission spectroscopic analyzer (ICP-AES, Agilent Technology Co., Ltd., Agilent 5110 VDV type or kind), and the Al element and P element included in the endothermic particles or radical scavenger of each Example and Comparative Example were quantitatively analyzed.

### Specific Surface Area (BET)

The specific surface area (BET calculated based on the adsorption isotherm measured by adsorbing water vapor) of the inorganic particles or composite particles was measured utilizing a gas adsorption amount measuring device (BELSORP manufactured by Microtrac Bell), according to JIS K6217-2.

### Mass of Desorbed Gas

Thermal desorption gas mass spectrometry (TDS-MS) was conducted by utilizing a thermal desorption gas mass spectrometer (TDS-1200, ESCO, Ltd.) to measure and analyze each desorbed amount of methane molecules, methanol molecules, benzene molecules, diphosphorus molecules, and water molecules, as follows.

In TDS, the sample materials were set by utilizing a sample stage made of quartz and a sample dish made of SiC. For example, the temperature increase rate was 60° C./min. The temperature increase was controlled or selected by monitoring a temperature on the sample surface. Furthermore, a weight of the sample was 1 milligram (mg), which was corrected by an actual weight. A quadruple mass spectrometer was utilized for a detection, and a voltage applied thereto was 1000 V.

TDS was utilized to measure an amount (micromole per gram (μmol/g)) of each gas desorbed from the inorganic particles or composite particles during the temperature increase from 80° C. to 1400° C. The mass number [M/z] utilized for analyzing the measurements was 15 for CH₄, 18 for H₂O, 31 for CH₃OH, 62 for P₂, and 78 for C₆H₆, wherein gases corresponding to the mass numbers were all each of the aforementioned substances. Herein, regarding the gas amount of H₂O, an integrated value only from 80° C. to 200° C. out of the entire temperature range was utilized to obtain the desorbed H₂O amount (MS2).

### Evaluation of Particle Diameter

The particle diameter of the composite particle, endothermic particle, or particle mixture was evaluated as D₅₀, 50% of the integrated value of the particle size distribution based on the particle diameter volume in the particle size distribution obtained by laser diffraction/scattering method. D₅₀ was measured utilizing the following equipment and conditions.

### Measuring Device: Laser Diffraction/Scattering Particle Diameter Distribution Measuring Device MT3300 (Manufactured by Micro Track Bell)

Permeability: Permeable

Shape: Non-spherical

Circulation speed: 7

Measurement time: 30 seconds

Number of repetitions: 3

Refractive index:

a. Composite particles, endothermic particles, or particle mixtures: 1.65

b. Ethanol solvent: 1.36

### Evaluation of Rechargeable Battery Cells

### Cycle Characteristics

The rechargeable battery cells according to Examples 1 to 16 and Comparative Examples 1 to 7 were charged under a constant current to 4.3 V at 0.1 CA of design capacity and charged under a constant voltage to 0.05 CA still at 4.3 V in a 25° C. thermostat. Subsequently, the cells were discharged under a constant current to 3.0 V at 0.1 CA. In some embodiments, the cells were measured with respect to initial discharge capacity after the 1^{st} cycle through a constant current charge at 0.2 CA, a constant voltage charge at 0.05 CA, and a constant current discharge at 0.2 CA under conditions of a charge cut-off voltage of 4.3 V and a discharge cut-off voltage of 3.0 V in the 25° C. thermostat. The rechargeable battery cells were 100 cycles charged and discharged through a constant current charge at 0.5 CA, a constant voltage charge at 0.05 CA, and a constant current discharge 0.5 CA under conditions of a charge cut-off voltage of 4.3 V and a discharge cut-off voltage of 3.0 V at 45° C. to test a cycle-life. After the 100 cycles, discharge capacity at a constant current charge of 0.2 CA, a constant voltage charge of 0.05 CA, and a discharge at 0.2 CA of the cells was measured and was divided by the initial discharge capacity to obtain capacity retention after the 100 cycles.

### Heating Test

The rechargeable battery cells according to Examples 1 to 16 and Comparative Examples 1 to 7 were charged under a constant current to 4.3 V at design capacity of 0.1 CA and charged under a constant voltage at 4.3 V to 0.05 CA in the 25° C. thermostat. Subsequently, the cells were discharged to 3.0 V at 0.1 CA under a constant current. In some embodiments, in the 25° C. thermostat, after performing a constant current charge at 0.2 CA, a constant voltage charge at 0.05 CA, and a constant current discharge at 0.2 CA under conditions of a charge cut-off voltage of 4.3 V and a discharge cut-off voltage of 3.0 V as 1 cycle, the cells were charged again under a constant current/constant voltage to 4.42 V, which were regarded as initial cells. These rechargeable battery cells were left for 1 hour in a thermostat heated to 165° C., and a case where a voltage of a battery cell became 4.3 V or less was regarded as “abnormal occurrence,” and an abnormal occurrence rate was evaluated in 10 individual battery tests.

### Nail Penetration Test

A nail penetration test was conducted by penetrating the aforementioned initial cells in the center with a nail having a diameter of 3 mm at 1 millimeter per second (mm/s). A case where an external temperature of a battery cell reached 50° C. or higher 5 seconds after being penetrated with the nail was regarded as “abnormal occurrence,” and an abnormal occurrence rate was evaluated in 10 individual battery tests.

### Overcharge Test

A case where an external temperature of a battery cell reached 50° C. or higher after additionally charging the aforementioned initial cells under a constant current to 12 V at 3 CA and then, charging them under a constant voltage for 10 minutes after reaching 12 V was regarded as “abnormal occurrence,” an abnormal occurrence rate was evaluated in 10 individual battery tests.

### Evaluation Results

The types (kinds) and physical properties of the heat suppressing additives utilized in the examples and comparative examples described herein are shown in Table 1. In some embodiments, the evaluation results for the rechargeable battery cells of Examples 1 to 16 and Comparative Examples 1 to 7 are summarized in Table 2.

TABLE 1

| | | | | | | Desorption gas mass | | | | | |
|---|---|---|---|---|---|---|---|---|---|---|---|
| | | | Specific | Element | | | | Mass | | | |
| | Heat | | surface | amount | | | | ratio of | | | |
| | suppressing | D₅₀ | area | Al | P | MS1 | MS2 | desorbed | MS3 | MS4 | MS5 |
| | additive | (μm) | (m²/g) | (%) | (%) | (μmol/g) | (μmol/g) | gases | (μmol/g) | (μmol/g) | (μmol/g) |
| Ex. 1 | Composite | 3.5 | 21 | 17 | 20 | 1210 | 571 | 2.1 | 35 | 267 | 11 |
| | particle A | | | | | | | | | | |
| Ex. 2 | Composite | 7.0 | 68 | 11 | 26 | 1613 | 851 | 1.9 | 35 | 267 | 12 |
| | particle B | | | | | | | | | | |
| Ex. 3 | Composite | 1.8 | 58 | 8 | 9 | 583 | 721 | 0.8 | 418 | 2941 | 2841 |
| | particle C | | | | | | | | | | |
| Ex. 4 | Composite | 1.1 | 48 | 6 | 15 | 904 | 751 | 1.2 | 209 | 1612 | 1475 |
| | particle D | | | | | | | | | | |
| Ex. 5 | Composite | 0.2 | 28 | 7 | 16 | 987 | 734 | 1.3 | 209 | 1601 | 1473 |
| | particle E | | | | | | | | | | |
| Ex. 6 | Composite | 1.5 | 74 | 21 | 12 | 740 | 871 | 0.8 | 35 | 267 | 10 |
| | particle F | | | | | | | | | | |
| Ex. 7 | Composite | 1.6 | 51 | 6 | 15 | 910 | 721 | 1.3 | 221 | 1588 | 1489 |
| | particle G | | | | | | | | | | |
| Ex. 8 | Composite | 1.7 | 21 | 17 | 20 | 1189 | 621 | 1.9 | 45 | 281 | 21 |
| | particle H | | | | | | | | | | |
| Ex. 9 | Composite | 1.8 | 67 | 7 | 26 | 1603 | 820 | 2.0 | 0 | 0 | 0 |
| | particle I | | | | | | | | | | |
| Ex. 10 | Composite | 1.3 | 41 | 7 | 16 | 958 | 741 | 1.3 | 221 | 1581 | 1421 |
| | particle J | | | | | | | | | | |
| Ex. 11 | Composite | 1.2 | 68 | 11 | 26 | 1598 | 824 | 1.9 | 35 | 267 | 12 |
| | particle K | | | | | | | | | | |
| Ex. 12 | Composite | 1.5 | 23 | 17 | 20 | 1200 | 601 | 2.0 | 32 | 267 | 11 |
| | particle L | | | | | | | | | | |
| Ex. 13 | Composite | 3.2 | 62 | 11 | 26 | 1592 | 821 | 1.9 | 31 | 281 | 13 |
| | particle M | | | | | | | | | | |
| Ex. 14 | Composite | 2.9 | 38 | 7 | 16 | 992 | 725 | 1.4 | 205 | 1605 | 1501 |
| | particle N | | | | | | | | | | |
| Ex. 15 | Composite | 3.5 | 21 | 17 | 20 | 1198 | 598 | 2.0 | 32 | 258 | 10 |
| | particle O | | | | | | | | | | |
| Ex. 16 | Composite | 3.5 | 42 | 7 | 16 | 962 | 752 | 1.3 | 220 | 1525 | 1420 |
| | particle P | | | | | | | | | | |
| Comp. | | — | | | | | | | | | |
| Ex. 1 | | | | | | | | | | | |
| Comp. | Aluminum | 3.0 | 205 | 32 | 0 | 0 | 60 | 0.0 | 0 | 0 | 0 |
| Ex. 2 | hydroxide | | | | | | | | | | |
| | particles | | | | | | | | | | |
| Comp. | Pseudo- | 1.8 | 384 | 32 | 0 | 0 | 1885 | 0.0 | 0 | 0 | 0 |
| Ex. 3 | boehmite | | | | | | | | | | |
| | particles | | | | | | | | | | |
| Comp. | Diphenyl | — | — | 0 | 12 | 765 | 0 | — | 418 | 3102 | 2950 |
| Ex. 4 | phosphate | | | | | | | | | | |
| Comp. | Composite | 13.0 | 76 | 26 | 8 | 425 | 985 | 0.4 | 18 | 124 | 2 |
| Ex. 5 | particle Q | | | | | | | | | | |
| Comp. | Particle | 5.0 | 10 | 16 | 16 | 493 | 21 | 23.5 | 0 | 0 | 0 |
| Ex. 6 | mixture a | | | | | | | | | | |
| Comp. | Particle | 1.8 | 192 | 16 | 6 | 185 | 943 | 0.2 | 421 | 2951 | 2912 |
| Ex. 7 | mixture b | | | | | | | | | | |

TABLE 2

| | Discharge | Heating | Nail | Overcharge |
|---|---|---|---|---|
| | capacity | test | penetration | test |
| | retention rate | abnormal | test abnormal | abnormal |
| | after 100 cycles | occurrence | occurrence | occurrence |
| | (%) | (%) | (%) | (%) |
| Ex. 1 | 90.1 | 0 | 10 | 10 |
| Ex. 2 | 90.2 | 0 | 10 | 10 |
| Ex. 3 | 90.2 | 0 | 10 | 10 |
| Ex. 4 | 90.1 | 0 | 10 | 0 |
| Ex. 5 | 90.2 | 0 | 0 | 0 |
| Ex. 6 | 90.2 | 0 | 20 | 20 |
| Ex. 7 | 90.3 | 0 | 10 | 10 |
| Ex. 8 | 90.2 | 0 | 10 | 10 |
| Ex. 9 | 90.3 | 0 | 0 | 0 |
| Ex. 10 | 90.2 | 0 | 10 | 10 |
| Ex. 11 | 90.3 | 0 | 10 | 0 |
| Ex. 12 | 90.3 | 0 | 10 | 0 |
| Ex. 13 | 90.2 | 0 | 0 | 0 |
| Ex. 14 | 90.3 | 0 | 10 | 10 |
| Ex. 15 | 90.3 | 0 | 10 | 0 |
| Ex. 16 | 90.2 | 0 | 10 | 0 |
| Comp. Ex. 1 | 90.2 | 100 | 100 | 100 |
| Comp. Ex. 2 | 87.2 | 70 | 100 | 90 |
| Comp. Ex. 3 | 86.5 | 70 | 80 | 90 |
| Comp. Ex. 4 | 85.8 | 80 | 80 | 100 |
| Comp. Ex. 5 | 89.1 | 50 | 70 | 70 |
| Comp. Ex. 6 | 86.8 | 80 | 90 | 90 |
| Comp. Ex. 7 | 86.2 | 90 | 90 | 90 |

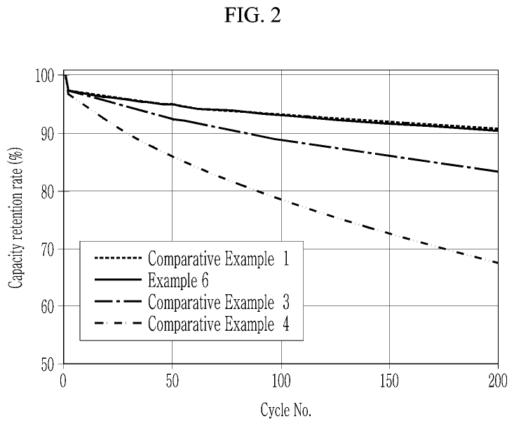

FIG. 2 is a graph of the discharge capacity retention rates for the rechargeable battery cells manufactured in Example 6, Comparative Example 1, Comparative Example 3, and Comparative Example 4 shown in Tables 1 and 2.

### Confirmation of Exothermic Behavior Under Coexistence of Charged Positive Electrode and Electrolyte

The initial cells of the fully charged rechargeable battery cells manufactured in Example 2 and Comparative Example 1 shown in Table 1 and Table 2 were disassembled in a glove box, and the positive electrodes were washed with dimethyl carbonate solvent and dried, and the obtained positive electrodes were utilized as a “charged positive electrode.”

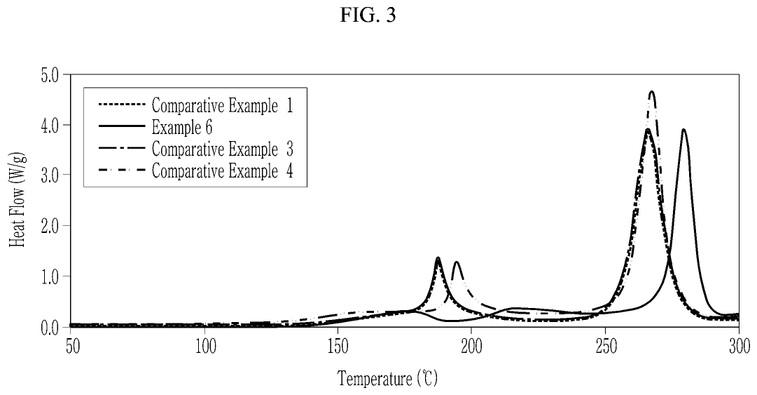

2.0 mg of the “charged positive electrode” and 1.0 mg of the same electrolyte utilized if (e.g., when) manufacturing the rechargeable battery cell were placed in an airtight container, caulked, and then utilizing a differential scanning calorimetry device, DSC (manufactured by Hitachi High-Tech Science), the temperature was raised at a temperature increase rate of 5 K/min in accordance with the provisions of JISK7121, and the exothermic behavior was evaluated. The results are shown in FIG. 3.

### Review on Examples and Comparative Examples

From the results in Table 2, compared to Comparative Examples 2 to 4 including only either a metal hydroxide or a radical scavenger, as well as Comparative Example 1 including no heat suppressing additive, in Examples 1 to 16, even under conditions where the internal temperature of the battery is likely to rise, (i.e., high temperature conditions, external impact from nailing, or overcharging), the abnormal occurrence rate caused by temperature rise inside the battery could be sufficiently suppressed or reduced. This effect is also shown by the disappearance of the exothermic peak between 150° C. and 250° C. in the exothermic behavior in FIG. 3.

In some embodiments, even when compared with Comparative Example 5, which includes composite particles as a heat suppressing additive but has a D₅₀ of 13 μm, and when compared with Comparative Examples 6 and 7, which include a particle mixture including the same components as the composite particles according to the present disclosure; in Examples 1 to 16, the abnormal occurrence rates caused by temperature rise inside the battery cells can be sufficiently suppressed or reduced unlike in the comparative examples.

Furthermore, from the results in Table 2 and FIG. 2, in Comparative Examples 2 to 7, the addition of one or more suitable heat suppressing additives resulted in lower cycle characteristics than Comparative Example 1 without the addition of the heat suppressing additive, but in Examples 1 to 16, cycle characteristics equivalent to those of Comparative Example 1 may be maintained.

From the described experimental results, according to the present disclosure, composite particles having both (e.g., simultaneously) an endothermic effect and radical scavenging ability are made, and the D₅₀ range of the composite particles is appropriately adjusted to increase the density of the positive electrode active material particles in the positive electrode mixture layer as much as possible. It is possible to arrange as many composite particles as possible around the positive electrode active material particles without deterioration. As a result, oxygen and radicals generated from the positive electrode active material are captured in the temperature range of 150° C. to 300° C., and the decomposition reaction of the electrolyte is effectively suppressed or reduced, thereby sufficiently suppressing the increase in the internal temperature of the battery and suppressing deterioration of battery performance such as cycle characteristics.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims, and equivalents thereof.

What is claimed is:

1. Composite particles, the composite particles comprising a metal hydroxide and a flame retardant,
wherein,
the composite particles are for a non-aqueous electrolyte rechargeable battery,
an amount of desorbed P₂ (MS1) of the composite particles from about 80° C. to about 1400° C. as determined by thermal desorption gas mass spectrometry (TDS-MS) is greater than or equal to about 200×10⁻⁶ mole per gram (mol/g) and less than or equal to about 2500×10⁻⁶ mol/g,
an amount of desorbed H₂O (MS2) of the composite particles from about 80° C. to about 200° C. as determined by TDS-MS is greater than or equal to about 50×10⁻⁶ mol/g and less than or equal to about 1000×10⁻⁶ mol/g, and
an integrated value of a volume-based particle size distribution of the composite particles is greater than or equal to about 0.1 micrometer (μm) and less than or equal to about 8 μm.

2. The composite particles as claimed in claim 1, wherein
a specific surface area (BET) of the composite particles calculated by an adsorption isotherm measured by adsorbing nitrogen on to the composite particles is greater than or equal to about 8 square meter per gram (m²/g) and less than or equal to about 150 m²/g.

3. The composite particles as claimed in claim 1, wherein
a ratio of MS1 and MS2 satisfies Formula (1):
0.5≤(MS1/MS2)≤10.0 (1).

4. The composite particles as claimed in claim 1, wherein
the metal hydroxide is at least one selected from among aluminum hydroxide, pseudo-boehmite, boehmite, alumina, and kaolinite, and a surface and an interior of the metal hydroxide are modified with the flame retardant.

5. The composite particles as claimed in claim 1, wherein
the flame retardant comprises at least one of phosphoric acid, phosphoric acid ester, phosphonic acid, or phosphinic acid.

6. The composite particles as claimed in claim 1, wherein
an amount of an aluminum element is about 1 mass % to about 50 mass % and an amount of a phosphorus element is about 1 mass % to about 50 mass % as determined by inductively coupled plasma emission spectroscopy (ICP-AES).

7. The composite particle as claimed in claim 1, wherein
an amount of desorbed CH₄ (MS3) of the composite particles from about 80° C. to about 1400° C. as determined by TDS-MS is greater than or equal to about 30×10⁻⁶ mol/g and less than or equal to about 500×10⁻⁶ mol/g, and an amount of desorbed CH₃OH (MS4) of the composite particles from about 80° C. to about 1400° C. as determined by TDS-MS is greater than or equal to about 500×10⁻⁶ mol/g and less than or equal to about 3000×10⁻⁶ mol/g.

8. The composite particles as claimed in claim 1, wherein
an amount of desorbed C₆H₆ (MS5) of the composite particles from about 80° C. to about 1400° C. as determined by TDS-MS is greater than or equal to about 100×10⁻⁶ mol/g and less than or equal to about 3000×10⁻⁶ mol/g.

9. The composite particles as claimed in claim 1, wherein the metal hydroxide has a D₅₀ value greater than or equal to about 10 nanometer (nm) and less than or equal to about 10 μm.

10. The composite particles as claimed in claim 1, wherein an amount of the metal hydroxide is greater than or equal to about 1 mass % and less than or equal to about 50 mass %, based on a total weight, 100 mass % of the composite particles.

11. The composite particles as claimed in claim 1, wherein an amount of the flame retardant is greater than or equal to about 0.1 mass % and less than or equal to about 90 mass %, based on a total weight, 100 mass % of the composite particles.

12. A positive electrode, the positive electrode comprising
a positive electrode current collector and a positive electrode mixture layer on the positive electrode current collector,
wherein,
the positive electrode is for a non-aqueous electrolyte, and
the positive electrode mixture layer comprises a positive electrode active material and the composite particles as claimed in claim 1.

13. The positive electrode as claimed in claim 12, wherein an amount of the composite particles in the positive electrode mixture layer is greater than or equal to about 0.1 mass % and less than or equal to about 5 mass %.

14. A non-aqueous electrolyte rechargeable battery, the non-aqueous electrolyte rechargeable battery comprising
a positive electrode, a negative electrode, a separator, and a non-aqueous electrolyte,
wherein the positive electrode is the positive electrode as claimed in claim 9.

15. The non-aqueous electrolyte rechargeable battery as claimed in claim 14, wherein an amount of the composite particles is greater than or equal to about 0.1 mass % and less than or equal to about 3.0 mass %, based on a total weight of the non-aqueous electrolyte rechargeable battery.

16. A method of preparing composite particles for a non-aqueous electrolyte rechargeable battery, the method comprising:
mixing metal hydroxide particles and a flame retardant to form a mixture; and
heating the mixture.

17. The method as claimed in claim 16, wherein mixing comprises a stirring speed greater than or equal to about 50 meter per minute (m/min) and less than or equal to about 500 m/min.

18. The method as claimed in claim 16, wherein heating comprises heating the mixture to greater than or equal to about 40° C. and less than or equal to about 100° C.

19. The method as claimed in claim 18, wherein heating further comprises reacting the mixture at greater than or equal to about 40° C. and less than or equal to about 100° C. for greater than or equal to about 1 hour and less than or equal to about 48 hours.
